(19) United States
(12) Patent Application Publication
(10) Pub. No.: US 2008/0142297 A1
(43) Pub. Date: Jun. 19, 2008

(54) Survival tower

(76) Inventor: Gilles Desrosiers, Sainte-Catherine (CA)

Correspondence Address: Franz BONSANG, c/o EQUINOX PROTECTION, 410-1500, Du College, St-Laurent, QC, H4L 5G6, omitted

(21) Appl. No.: 12/071,417

(22) Filed: Feb. 21, 2008

Related U.S. Application Data
(63) Continuation-in-part of application No. 11/009,918, filed on Dec. 8, 2004.
(60) Provisional application No. 60/527,246, filed on Dec. 8, 2003.

(51) Int. Cl. A62B 1/20

(52) U.S. Cl. 182/48

(57) ABSTRACT

A survival tower for use in the event of an emergency inside a building provides improved control of traffic inside an emergency chute as well as improved management for smoke and flames. While sliding down the chute, users are temporarily slowed down or decelerated whenever they approach a lower chute entrance being used by another user, to leave enough time for the entering user to safely engage the chute. At the lower end of the chute, the users are gradually slowed down for a smooth finish of their downward traversal of the slide. The tower can be built inside or outside building walls.

### CROSS-REFERENCE TO RELATED APPLICATIONS

The present application is a Continuation-In-Part (C.I.P.) of U.S. patent application Ser. No. 11/009,918 filed on Dec. 8, 2004, now abandoned, and which claimed benefit of U.S. Provisional Application for Patent Ser. No. 60/527,246, filed on Dec. 8, 2003.

### FIELD OF THE INVENTION

The invention relates generally to rescue and safety equipment and structure but more particularly to a fire/emergency evacuation tower for buildings having a plurality of stories, including skyscrapers.

### BACKGROUND OF THE INVENTION

Constructing emergency escape structures for buildings has been known for years and several systems have been developed consisting of an upright tube containing a spiral slide extending throughout its length with access doors along the sides of the tube to allow people to use the device.

Some chutes are made of a double tubular body having an inner cylinder and an outer cylinder made of cloth while other structures are made of rigid material.

Besides spiral escapes, there are also elongated or rectangular configuration chutes having a bottom, side walls and a top. Also, vertical stretchable conduits which slow down descent speed by virtue of the fact that they squeeze the users or else offer a soft slightly zigzagging course.

In all cases doorways or hatches of some sort separate the chute from the rest of the building so that smoke or flames won't enter into the chute.

The problems with such systems has to do with managing oncoming traffic from new users trying to get in and also stopping fire and smoke from entering the rescue chute.

Accordingly, there is a need for an improved survival tower.

### SUMMARY OF THE INVENTION

It is therefore a general object of the present invention to provide an improved survival tower.

As advantages, the present invention has a new system for controlling traffic inside an emergency chute as well as a new management system for smoke, fumes and flames. Instead of trying to keep smoke, fumes and flames outside, the system works at eliminating it as soon as it gets in by recirculating the air. As for managing people, they are temporarily slightly decelerated each time they approach a new entrance only, and more decelerated if a new user gets in there through. Also, a system for receiving people at the end of the chute which gradually decelerate them down offers a smooth finish to the emergency down ride. The system can be built inside a building or built outside such as to retrofit an existing building. A system of vertical ladders also serves as backup should there be any problem with the chute as well as “firemen poles” and a floor by floor elevator system for emergency personnel such as first aid provider and firemen.

In accordance with an aspect of the present invention, there is provided a survival tower for rescuing people in an emergency from a building having a plurality of stories, the tower comprising:
a tower structure located adjacent to or within the building and having a spiraling down chute;
at least one access opening on one of the stories of the building, the access opening being closable by a corresponding access door;
a tipping floor located adjacent said access opening and said chute, said tipping floor being tippable between a floor first position and a floor second position, said tipping floor being substantially disconnected from said chute when in said floor first position and substantially connecting with said chute when in said floor second position;
a chute decelerating means for selectively and locally decelerating a user of said chute located on said chute adjacent said access opening; and
an actuating mechanism connected to said chute decelerating means and said tipping floor, said actuating mechanism selectively activating said chute decelerating means when said tipping floor is away from said floor first position.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a front elevation view of a building having an embodiment of a survival tower in accordance with the present invention;

FIG. 2 is a side elevation view of the embodiment of FIG. 1;

FIG. 3 is a plan view of the tower structure and chute of the embodiment of FIG. 1, with users but without the chimney;

FIG. 4 is a plan view of the tower structure of the embodiment of FIG. 1, showing the chimney;

FIG. 5 is an enlarged broken section view taken along line 5 of FIG. 2;

FIG. 6 is an enlarged broken section view taken along line 6 of FIG. 3;

FIG. 7 is a schematic enlarged broken section view taken along line 7-7 of FIG. 6;

FIG. 8 is a schematic enlarged broken section view taken along line 8-8 of FIG. 6; and

FIG. 9 is a schematic enlarged broken section view taken along line 9-9 of FIG. 6.

### DETAILED DESCRIPTION OF THE PREFERRED EMBODIMENTS

With reference to the annexed drawings the preferred embodiments of the present invention will be herein described for indicative purpose and by no means as of limitation.

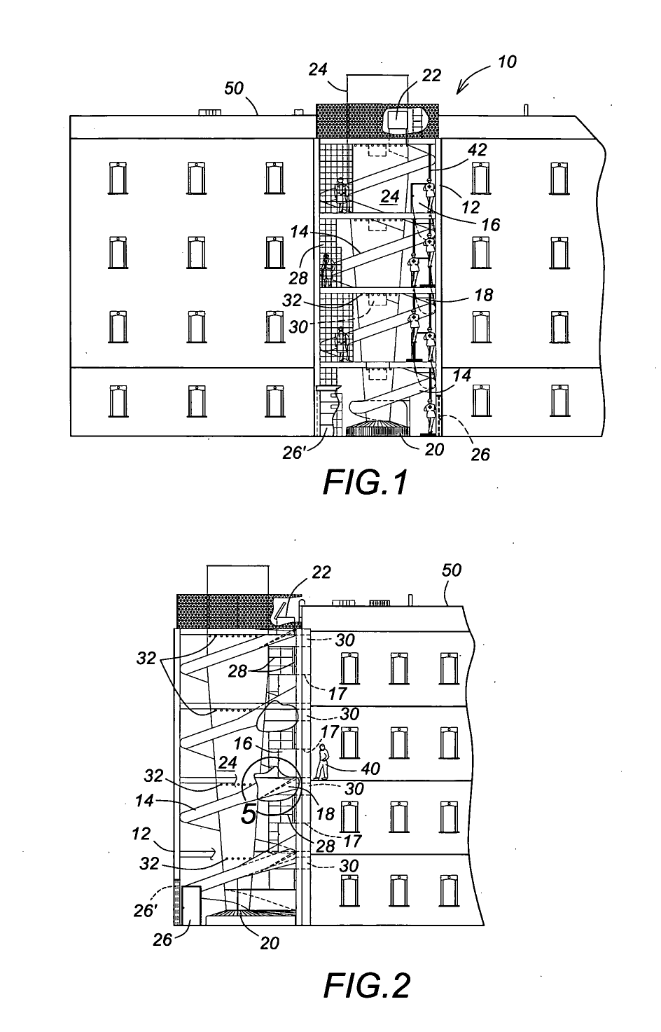

As shown in FIGS. 1 to 4, a survival tower 10 has a tower structure 12 which can be set either inside of a building or to the outside and adjacent to a building 50. Obviously the survival tower 10 is built with fire proof or at least fire retardant materials. The tower structure 12 contains a chute 14 which is a long half tubular structure spiraling down towards the ground. Being half tubular in the sense of being “U” shaped like a tube being cut halfway along its length so that the chute 14 is not a closed environment but rather an open, non claustrophobic environment which is more conducive to adequate air flow and ventilation.

At each floor, or story, is a fire retardant access door 16 for closing a corresponding access opening 17. The access door 16, that typically opens into the tower structure 12, is substantially lower than a conventional building door, standard doorway height of construction standards as used for the passage of human beings (as seen in the upper floor of FIG. 1 with the top of the access door substantially reaching the shoulder level of the user), typically lower than about six feet (6 ft) and preferably in the order of between about four to five foot high (4-5 ft), so as to keep smoke from entering the chute 14, since smoke tends to stay higher.

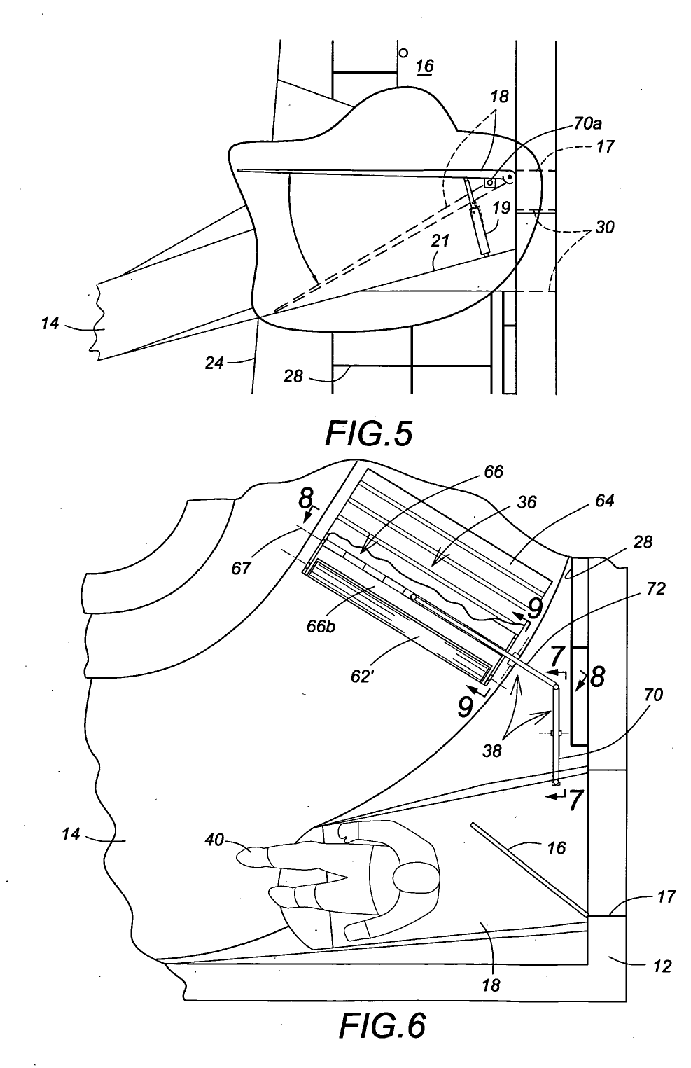

Once a user 40 steps past the access door 16 he walks onto a tipping floor 18, also typically of “U” shaped like a tube, which drops from a generally horizontal first orientation or position, as shown in solid lines in FIG. 5, down to a generally inclined second orientation or position, as shown in dotted lines in FIG. 5, so as to join in with the chute 14 in such a way as to acts as a gangway of sort which selectively leads the user 40 onto the chute 14. The user 40 will then slide down the chute 14 all the way to a landing platform 20, preferably but not necessarily a rotating landing platform 20 which rotates in a manner similar to an airport carrousel. From the base of the tower structure 12, exit doorways, such as a conventional emergency exit door 26 and a garage door 26′, lead outside.

As shown in FIG. 5, the tipping floor 18 is typically biased to return to its horizontal first position after the user 40 has cleared it and engaged the chute 14, and be ready for the next user 40, via a biasing means such as a damper pneumatic cylinder 19, a coil spring (not shown) or the like, that could preferably be adjustable. The tipping floor 18 is a reassuring device which helps the user 40 who may otherwise panic and not know exactly how to enter into the chute 14. The tipping floor 18 typically moves from the first position to the second position under the weight of the user 40 engaging the same. The damper cylinder 19 typically movably connects to the underside of the tipping floor 18 and the subjacent floor structure 21.

Along the chute 14, just upstream of each merging with a tipping floor 18, there is a decelerating means 36 which is selectively actuated, via an actuating mechanism 38 connecting to the tipping floor 18 and the corresponding decelerating means 36, when the tipping floor 18 is actuated by a user 40. Although the decelerating means 36 locally decelerates down the users 40 coming down the chute 14 from an upper story so as to prevent the chute users 40 from continuously accelerating while sliding down many stories, it decelerates even more such users, when activated, such that a sliding user does not dangerously hit or interfere with another user 40 entering the chute 14 from the adjacent tipping floor 18. When the decelerating means 36 is not activated, it typically allows a user 40 located thereon to slightly decelerate and normally move down the chute 14, adjacent a chute access, when no one enters the chute there through.

As shown in FIG. 6, the decelerating means 36 typically comes in the form of a mat consisting of a series of free rotation rollers 62 covered by a membrane 64 rolling thereon, similar to a treadmill, and when at least one of the rollers 62, the left most roller 62′ of FIG. 9, is temporarily blocked or displaced away from the others to put the membrane 64 under tension, the rolling of the membrane 64 is hampered or impeded to decelerate the users 40 located thereon while the corresponding tipping floor 18 is activated.

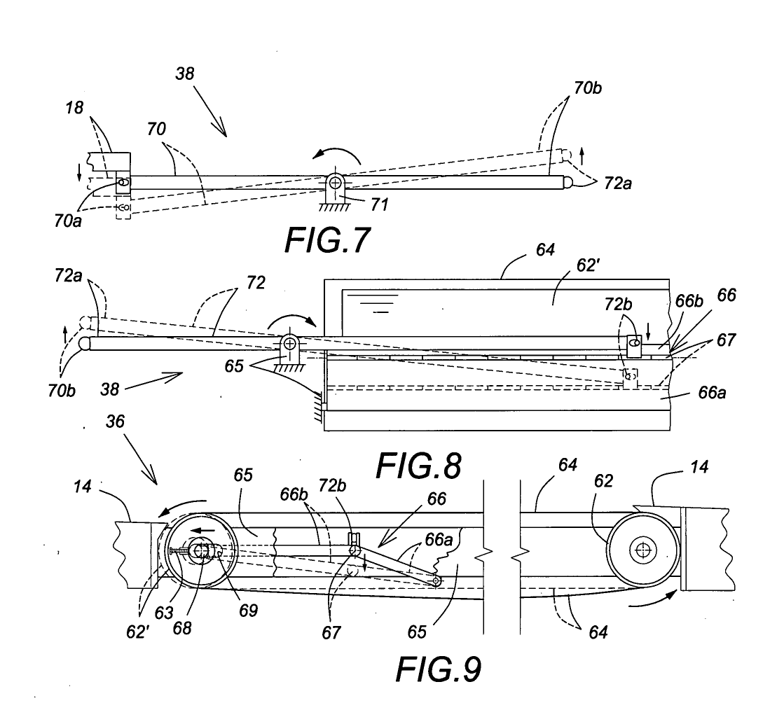

As shown in FIGS. 7 and 8, the actuating mechanism 38 typically includes a main link bar 70 pivotally mounted on a fixed structure 71, at a location between the main bar first 70a and second 70b ends pivotally and/or slidably connected to the tipping floor 18 and to a secondary link bar 72, respectively. Similarly, the secondary bar 72 pivotally mounts on a fixed structure 65 of the chute 14, at a location between the secondary bar first 72a and second 72b ends pivotally and/or slidably connected to the main bar second end 70b and to a hinge assembly 66 of the decelerating means 36, respectively. When the tipping floor 18 is displaced from the floor first position, shown in solid lines in FIG. 7, to the floor second position, shown in dotted lines in FIG. 7, the main bar first end 70a moves downward and the main bar second end 70b moves upward, which forces the secondary bar first end 72a to move upward, and the secondary bar second end 72b to move downward, as shown in solid and dotted lines in FIG. 8, respectively.

As shown in FIG. 9, the decelerating means 36 typically includes the hinge assembly 66 formed of the hinge first 66a and second 66b plates that are pivotable relative to one another about hinge axis 67 connected to the secondary bar second end 72b. The hinge first plate 66a is typically pivotally mounted on the structure 65 of the chute 14 about while the hinge second plate 66b is pivotally mounted on the shaft 68 of the left most roller 62′. The shaft 68 of the roller is slidably mounted within a slot hole 69 of the chute structure 65. When the secondary bar second end 72b moves downward, the hinge axis 67 moves downward and the shaft 68 of the left most roller 62′ slides within the slot hole 69 away from the other rollers 62, as shown in dotted lines in FIG. 9, to tighten and hamper the rolling of the membrane 64 thereon. A shaft abutment adjustment device 63, typically in the form of a screw mounted onto the chute structure 65, allows adjustment of the tension of the membrane 64, in the decelerating activated position, by controlling the sliding displacement limit of the shaft 68 within the slot hole 69.

A reader skilled in the art would understand that any of a number of mechanical, electrical, electromechanical, or electronic actuating mechanism can be used, without deviating from the scope of the present invention, to effect cooperation between the tipping floor 18 and the decelerating means 36, given that the tipping floor 18, by way of its tipping action, can act as a switch that turns on or off the operation of the decelerating means 36. It is well within the skills of any artisan to derive such mechanisms and as such, it needs not be further discussed herein. Similarly, the decelerating means 36 could have different embodiments, such as locally positioned and selectively inwardly extending chute walls or the like.

Wall openings 34 are made from the outside into the chute 14 itself to provide an influx of fresh air for the users and create a positive air pressure to keep the smoke from entering into the chute 14. The use of positive air pressure to keep gases or airborne particles outside a given area is well known in the art and need not be further discussed herein.

In order to control the heat, smoke (including toxic gases and other fumes) and flames, the central part of the tower structure 12 typically has a chimney 24, preferably with a general funnel shape and extending from the ground floor up to a few feet above the building roof, which collects fumes from the building 50 via collecting ducts 30. Additionally, circumferential holes 32 typically located around the inner perimeter of the chimney side wall collect smoke that made its way into the tower structure 12 from the access openings 17.

The tower structure 12 also has other features such as roof access 22 and a backup ladder 28 extending throughout all floors for use as a backup should there be any problem with the chute 14 or if for any of a number of reasons the chute 14 is no longer an option; or if a user 40 does not want to use the chute 14; or if going up to the roof is a better alternative, or to give access to the chute 14 from the roof of the building 50.

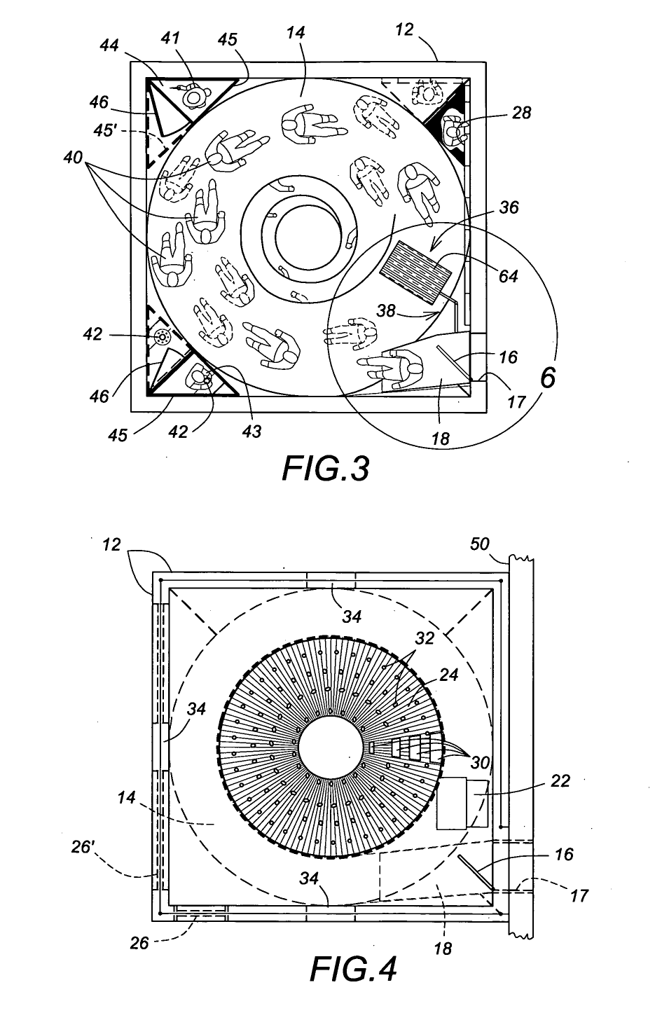

In order to facilitate the displacement of emergency personnel such as firefighters 41 and emergency medical teams 43, at least one sliding pole 42, with its associated cage 45 and cage door 46, and at least one elevator 44, with its associated cage 45 are typically part of the survival tower 10, preferably, but not necessarily, in the other remaining unused corners of the tower structure 12 (a corner with a chute entrance is considered a used corner). The elevator 44 is limited to moving up or down within a range of two floors with staggered cages 45, dotted cage 45; being on a lower floor on FIG. 3. The sliding pole 42 allows one to go from one floor down to the next subjacent floor and is also limited to within a two-floor range, also typically in staggered fashion. This limitation allows preventing tendency of smoke and fire to migrate across a large span of floors, and to prevent users to panic.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A survival tower for rescuing people in an emergency from a building having a plurality of stories, said tower comprising:
a tower structure located adjacent to or within the building and having a spiraling down chute;
at least one access opening on one of the stories of the building, the access opening being closable by a corresponding access door;
a tipping floor located adjacent said access opening and said chute, said tipping floor being tippable between a floor first position and a floor second position, said tipping floor being substantially disconnected from said chute when in said floor first position and substantially connecting with said chute when in said floor second position;
a chute decelerating means for selectively and locally decelerating a user of said chute located on said chute adjacent said access opening; and
an actuating mechanism connected to said chute decelerating means and said tipping floor, said actuating mechanism selectively activating said chute decelerating means when said tipping floor is away from said floor first position.

2. The tower of claim 1, wherein said tipping floor includes a damper member connected to said tipping floor, said damper member damping displacement of said tipping floor between said floor first and second positions is biased and biasing said tipping floor in said floor first position.

3. The tower of claim 2, wherein said chute decelerating means includes a mat having a membrane covering a plurality of rollers and being rollable thereon, at least one of said rollers being connected to said actuating mechanism to selectively hamper rolling of said membrane thereon.

4. The tower of claim 3, wherein said at least one of said rollers connected to said actuating mechanism is movable away from the other said rollers to selectively stretch said membrane and hamper rolling thereof on said rollers.

5. The tower of claim 1, wherein said chute is substantially half tubular.

6. The tower of claim 1, further including a landing platform to receive users at a lower end of said chute.

7. The tower of claim 6, wherein said landing platform is a rotating landing platform.

8. The tower of claim 1, wherein said access door is substantially lower in height than about 6 feet so as to limit smoke from entering said tower.

9. The tower of claim 8, wherein said access door is typically between about 4 feet and about 5 feet high.

10. The tower of claim 1, wherein said tower structure has a roof access.

11. The tower of claim 1, further comprising a backup ladder extending throughout all said stories as a backup to said chute.

12. The tower of claim 1, further comprising at least one elevator to allow emergency personnel to move between stories.

13. The tower of claim 12, wherein said at least one elevator is limited to move up or down between two adjacent said stories.

14. The tower of claim 12, wherein at least one elevator is situated in anyone of a plurality of remaining unused corners of the tower structure.

15. The tower of claim 1, further including at least one sliding pole between two adjacent said stories to allow emergency personnel to slide down from an upper one said stories to a lower one of said stories.

16. The tower of claim 15, wherein said at least one sliding pole has a range limited to within said two adjacent stories.

17. The tower of claim 15, wherein said at least one sliding pole is situated in anyone of a plurality of remaining unused corners of the tower structure.

18. The tower of claim 1, wherein said tipping floor is actuated from said floor first position toward said floor second position by the weight of a user engaging said tipping floor.

19. The tower of claim 1, further including a chimney generally centrally located within the tower structure and having a chimney side wall surrounded by said chute, said chimney side wall having collecting ducts extending between said chimney side wall corresponding said stories for collecting fumes and heat from said building.

20. The tower of claim 1, further including circumferential holes located on the chimney side wall for collecting smoke gathering into the tower structure.

21. The tower of claim 1, further including wall openings extending through an outside wall of the tower structure to provide an influx of fresh air to create a positive pressure within said structure.
